(19) United States
(12) Patent Application Publication
(10) Pub. No.: US 2007/0036605 A1
(43) Pub. Date: Feb. 15, 2007

(54) Print medium feeding cassette and image forming apparatus having the same

(75) Inventor: Kyeong-taeg Yang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/496,470

(22) Filed: Aug. 1, 2006

(30) Foreign Application Priority Data
Aug. 9, 2005 (KR) 10-2005-0072974

(51) Int. Cl. B41J 13/10

(52) U.S. Cl. 400/624

(57) ABSTRACT

A print medium feeding cassette and an image forming apparatus having the print medium feeding cassette are provided. The print medium feeding cassette includes a cassette frame having an inner space in which a print medium is stacked. The print medium is discharged from the inner space through an opening at one side of the cassette frame. A cleaning member is disposed proximal the opening to remove foreign substances from the surface of the print medium.

### CROSS-REFERENCE TO RELATED PATENT APPLICATION

This application claims the benefit under 35 U.S.C. § 119(a) of Korean Patent Application No. 10-2005-0072974, filed on Aug. 9, 2005, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to a print medium feeding cassette that removes foreign substances from the surface of a print medium to substantially prevent printing failure, and an image forming apparatus having the print medium feeding cassette.

2. Description of the Related Art

Image forming apparatuses that form an image on a print medium are classified into electrophotographic types, inkjet types, and electrothermal types, and each type can be divided into sub types based on various standards.

FIG. 1 is a top view of a print medium on which an image is printed by a conventional image forming apparatus, for example, a dye sublimation-type electrothermal image forming apparatus.

The electrothermal image forming apparatus includes a thermal print head (TPH) including a plurality of heat emitting elements arranged in the width direction of the print medium and that selectively emit heat. The image forming apparatus includes a direct coloring type that forms an image by directly applying heat to a special print medium that colors on receiving heat, and a dye sublimation type that forms an image on a print medium by subliming soaked dyes as an ink ribbon soaked with dyes is heated.

Referring to FIG. 1, when a print medium 10 passes through an image forming apparatus (not shown), an image (I) can be formed on one surface or both surfaces of the print medium. However, when a foreign substance 15, such as dust, is present on one surface of the print medium 10, the sublimated dyes are not attached on the foreign substance 15 and thus print failure may occur at that portion (B) of the image. A problem of printing failure due to the presence of a foreign substance is not limited to the dye sublimation-type image forming apparatus, and may also occur in a direct coloring-type image forming apparatus, an electrophotographic-type, or an inkjet-type image forming apparatus.

Thus, a need exists for an image forming apparatus that removes foreign substances from a surface of a print medium to substantially prevent printing errors.

### SUMMARY OF THE INVENTION

The present invention provides a print medium feeding cassette that removes foreign substances from the surface of a print medium, and an image forming apparatus having the print medium feeding cassette.

According to an aspect of the present invention, a print medium feeding cassette includes a cassette frame having an inner space in which a print medium is stacked and an opening at one side through which the print medium is discharged from the inner space. A cleaning member is provided around the opening to remove foreign substances from the surface of the print medium.

The cleaning member may include a sheet made of cotton flannel or felt that generates static electricity by friction against the print medium.

The print medium feeding cassette may further include a tray for stacking the print medium in the cassette frame and pressing the print medium toward the opening.

The cassette frame may have a cover that opens and closes to substantially prevent the print medium from being contaminated. The cleaning member may be attached to the inner surface of the cover.

According to another aspect of the present invention, an image forming apparatus includes a main body that contains a print engine for printing an image on a print medium and a print medium feeding cassette in which unprinted print media are piled and that is detachably fitted to the main body. The print medium feeding cassette includes a cassette frame having an inner space in which a print medium is piled and an opening at one side through which the print medium is discharged from the inner space. A cleaning member is provided around the opening to remove foreign substances from the surface of the print medium.

The cleaning member may include a sheet made of cotton flannel or felt that generates static electricity by friction against the print medium.

The print medium feeding cassette may further include a tray for stacking the print medium in the cassette frame and pressing the print medium toward the opening. The main body may have a pickup roller rotating above the opening and picking up the print medium sheet by sheet when the print medium feeding cassette is fitted into the main body.

The main body may further include a pickup plate pressing the tray toward the opening when the print medium feeding cassette is fitted into the main body.

The cassette frame may have a cover that opens and closes to substantially prevent the print medium from being contaminated. The cleaning member may be attached to the inner surface of the cover.

The print engine may include an ink ribbon holding ink for coloring the print medium, and a thermal print head that sublimates the ink on the ink ribbon by heating the ink ribbon to transfer the sublimed ink to the print medium.

Other objects, advantages, and salient features of the invention will become apparent from the detailed description, which, taken in conjunction with the annexed drawings, discloses exemplary embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 is a top view of a print medium on which an image is printed by a conventional image forming apparatus;

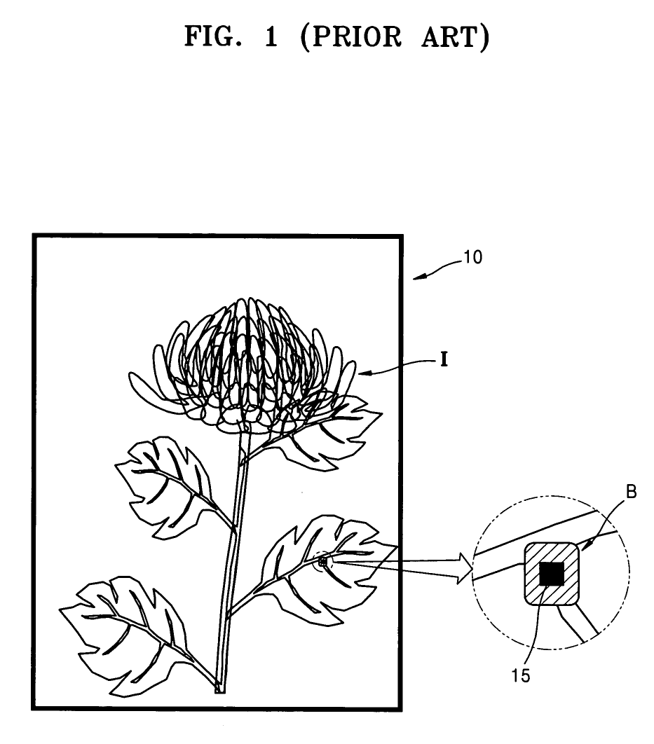

FIG. 2 is an elevational view in partial cross section of an image forming apparatus according to an exemplary embodiment of the present invention; and

FIG. 3 is a perspective view of a feeding cassette of FIG. 2.

Throughout the drawings, like reference numerals will be understood to refer to like parts, components and structures.

### DETAILED DESCRIPTION OF EXEMPLARY EMBODIMENTS

A print medium feeding cassette and an image forming apparatus having the print medium feeding cassette according to an exemplary embodiment of the present invention are described in detail with reference to the accompanying drawings.

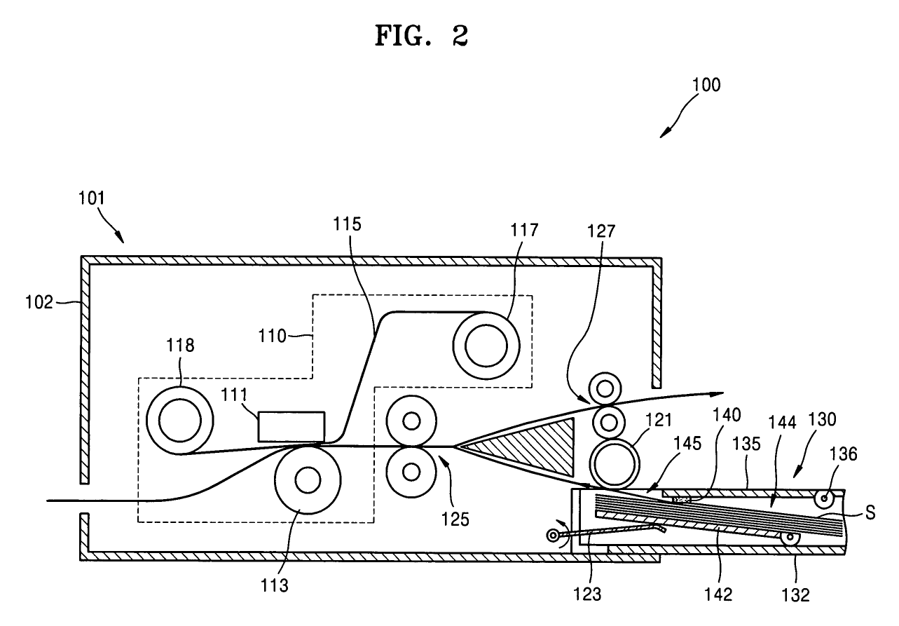

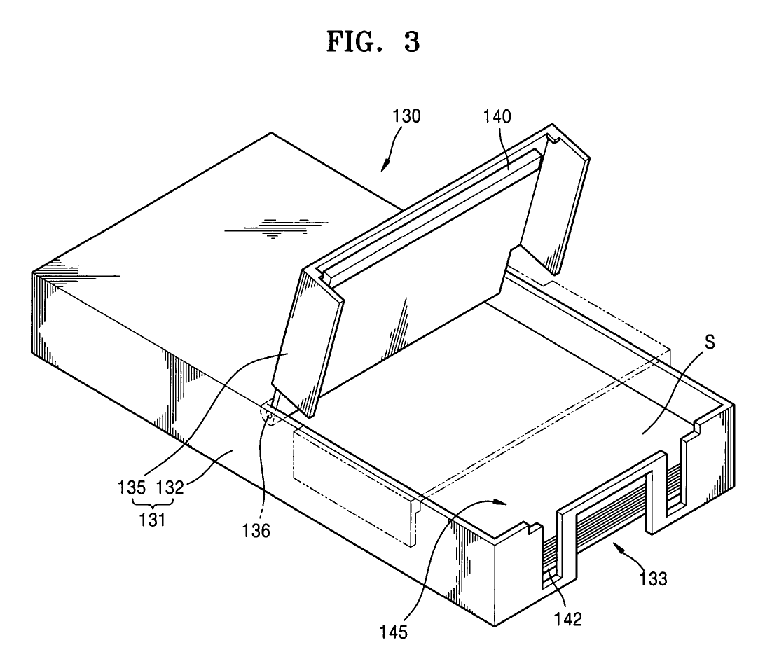

FIG. 2 is an elevational view in partial cross section of an image forming apparatus according to an exemplary embodiment of the present invention. FIG. 3 is a perspective view of a print medium feeding cassette of FIG. 2.

Referring to FIG. 2, the image forming apparatus 100 includes a main body 101 including a print engine 110 for printing an image on a print medium (S), and a feeding cassette 130 detachably mounted in the main body 101. The print engine 110 is disposed inside a case 102 forming a casing of the main body 101.

The print engine 110 includes an ink ribbon 115 that is soaked with dyes for coloring a print medium (S), and a TPH 111 that colors the print medium (S) by heating the ink ribbon 115 and transferring dyes from the ink ribbon 115 to the print medium (S). A plurality of heat emitting elements (not shown) are located in the TPH 111 in a width direction of the print medium (S), and selectively emit heat and color the print medium (S) as described above. The ink ribbon 115 is wound around a pair of ribbon support wheels 117 and 118 for sustaining tension. A platen roller 113 for pressing the print medium (S) and the ink ribbon 115 toward the heating element (not shown) of the TPH 111 is disposed under the TPH 111.

A pickup roller 121 picks up the print medium (S) loaded in the feeding cassette 130 one sheet at a time. A transfer roller 125 feeds the picked-up print medium (S) to a position between the TPH 111 and the platen roller 113 and transfers the print medium (S) in a direction substantially opposite to a feeding direction in a coloring process. A discharge roller 127 discharges the print medium (S) on which the printing is completed to outside of the main body 101. The pickup roller 121, the transfer roller 125 and the discharge roller 127 are disposed in the main body 101. The transfer roller 125 and the discharge roller 127 each rotate against an opposite roller, and one roller of each pair is a driving roller while the other roller is an idle roller.

An image formation process of the image forming apparatus 100 is described in detail below.

The print medium (S) loaded in the feeding cassette 130 is picked up by the pickup roller 121 and fed by the transfer roller 125 to a position between the TPH 111 and the platen roller 113, which are separated from each other. While the rear end of the print medium (S) is retained between the transfer rollers 125, the transfer rollers 125 stop rotating and the TPH 111 presses the ink ribbon 115 and the print medium (S) closely against the platen roller 113.

The transfer roller 125 pulls the print medium (S) disposed between the TPH 111 and the platen roller 113 by rotating in the direction opposite to the feeding direction to transfer the print medium in the direction of the discharge roller 127.

The ink ribbon 115 moves at the same speed as the print medium (S), and a plurality of heat elements (not shown) of the TPH 111 selectively emit heat, sublime dyes soaked in the ink ribbon, and color the print medium (S) to form an image on the print medium (S). The print medium (S) on which an image is thus formed is discharged to outside of the main body 101 by the discharge roller 127.

Referring to FIGS. 2 and 3, the feeding cassette 130 includes a cassette frame 131 having a base frame 132 and a cover 135 coupled to the base frame 132 by a hinge 136. An inner space 144 is provided inside the cassette frame 132 in which the print medium (S) may be loaded. A tray 142 may be raised and lowered within the inner space 144. The front end of the print medium (S) loaded in the inner space 144 is preferably supported by the tray 142.

The cover 135 covers an open top of the base frame 132. When the cover opens, an opening 145 of the top of the base frame 132 is increased to easily load the print medium (S) in the inner space 144. However, as shown by a broken line of FIG. 3, when the cover 135 is closed, the opening 145 is decreased so that only the front end of the loaded print medium (S) is exposed to substantially prevent contamination of the print medium (S) from the outside.

A cleaning member 140 for cleaning foreign substances, such as dust, from the surface of the print medium (S) is preferably disposed on an inner surface of the cover 135. The cleaning member 140 includes a sheet, preferably made of cotton flannel or felt, for generating static electricity by friction with the print medium (S). The foreign substance on the surface of the print medium (S) is drawn by static electricity onto the cleaning member 140 and removed from the surface of the print medium (S). The cleaning member 140 has a length greater than the width of the print medium (S) to substantially remove foreign substances from the entire surface of the print medium (S).

A pick-up plate 123, which presses the tray 142 toward the opening 145 when the feeding cassette 130 is mounted in the main body 101, is disposed under the pickup roller 121 of the main body 101. An entry portion 133 at a front end of the base frame 132 allows the pick-up plate 123 to be inserted under the tray 142 when the feeding cassette 130 is mounted in the main body 101.

A pickup process of the print medium (S) is described in detail below.

When the feeding cassette 130 loaded with the print medium (S) is mounted in the main body 101, the pick-up plate 123 is advanced through the entry portion 133 of the front end of the base frame 132 and positioned under the tray 142. The pickup roller 121 is positioned proximal the opening 145 of the top surface of the base frame 132. When the printing is started, the pickup roller 121 rotates and the pick-up plate 123 also rotates in the direction of an arrow of FIG. 2, thereby pressing the tray 142 upwardly toward the opening 145. Thereby, the front end of the print medium (S) loaded in the tray 142 is lifted toward the opening 145 and the pickup roller 121, and the top sheet of the print medium (S) is picked up by friction with the pickup roller 121 and advanced inside the main body 101.

The top print medium (S) of the tray 142 contacts the pickup roller 121 due to the raising of the tray 142, and also contacts the cleaning member 140 disposed on an inside surface of the cover 135. When the print medium (S) advances continuously into the main body 101, the cleaning member 140 removes foreign substances, such as dust, while continuously contacting the top surface of the print medium (S).

When the top print medium (S) feeds into the main body 101, the pick-up plate 123 rotates in a direction opposite to the arrow of FIG. 2 to prevent the next print medium (S) from being picked up. The pick-up plate 123 does not rotate again in the arrow direction until printing is finished and the print medium (S) is discharged to outside of the main body 101.

The feeding cassette according to an exemplary embodiment of the present invention and the image forming apparatus having the feeding cassette substantially prevent printing failure due to foreign substances by removing foreign substances from the surface of the print medium. Furthermore, repeated printing to obtain good print quality is not necessary, so that wasting time and resources, such as the print medium and the ink ribbon, is prevented.

The feeding cassette having the cleaning member of an exemplary embodiment of the present invention may be applied to, for example, a direct coloring-type electrothermal image forming apparatus, an inkjet-type image forming apparatus, and an electrophotographic-type image forming apparatus, as well as any other suitable printing apparatuses.

While the present invention has been particularly shown and described with reference to exemplary embodiments thereof, it will be understood by those skilled in the art that various changes in form and detail may be made therein without departing from the spirit and scope of the present invention as defined by the appended claims.

What is claimed is:

1. A print medium feeding cassette, comprising:
a cassette frame having an inner space in which a print medium is stacked and an opening at one side of the frame through which the print medium is discharged from the inner space; and
a cleaning member disposed proximal the opening to remove foreign substances from a surface of the print medium.

2. The print medium feeding cassette according to claim 1, wherein
the cleaning member generates static electricity by friction against the print medium to remove the foreign substances.

3. The print medium feeding cassette according to claim 2, wherein
the cleaning member is made of cotton flannel or felt.

4. The print medium feeding cassette according to claim 1, wherein
a tray is disposed in the cassette frame upon which the print medium is stacked and that presses the print medium toward the opening.

5. The print medium feeding cassette according to claim 1, wherein
a cover is connected to the cassette frame that is movable between an open position for loading the print medium and a closed position to substantially prevent the print medium from being contaminated.

6. The print medium feeding cassette according to claim 5, wherein
the cleaning member is connected to an inner surface of the cover.

7. The print medium feeding cassette according to claim 4, wherein
the cassette frame has an entry portion through which a pick-up plate is adapted to extend to engage the tray to facilitate moving the tray upwardly.

8. A method of removing foreign substances from a surface of a print medium, comprising the steps of
disposing the print medium in cassette frame of an image forming apparatus;
connecting a cleaning member to the cassette frame; and
removing foreign substances from the print medium when the print medium is drawn out of the cassette frame for a printing operation as the print medium passes the cleaning member.

9. A method of removing foreign substances from a surface of a print medium according to claim 8, further comprising generating static electricity by contacting the print medium with the cleaning member such that the static electricity removes foreign substances from the print medium.

10. A method of removing foreign substances from a surface of a print medium according to claim 8, wherein the print medium is disposed on a tray connected to the cassette frame.

11. A method of removing foreign substances from a surface of a print medium according to claim 10, further comprising biasing the print medium on the tray toward the cleaning member.

12. An image forming apparatus including a print medium feeding cassette, comprising:
a cassette frame adapted to receive a print medium; and
a cleaning member connected to the cassette frame and adapted to remove foreign substances from a surface of the print medium.

13. An image forming apparatus including a print medium feeding cassette according to claim 12, wherein
the cleaning member generates static electricity by frictionally contacting the print medium to remove the foreign substances from the print medium.

14. An image forming apparatus including a print medium feeding cassette according to claim 13, wherein
the cleaning member is made of cotton flannel or felt.

15. An image forming apparatus including a print medium feeding cassette according to claim 12, wherein
a tray is disposed in the cassette frame upon which the print medium is stacked.

16. An image forming apparatus including a print medium feeding cassette according to claim 15, wherein
the tray is biased towards the cleaning member.

17. An image forming apparatus including a print medium feeding cassette according to claim 15, wherein
a plate biases the tray towards the cleaning member.

18. An image forming apparatus including a print medium feeding cassette according to claim 12, wherein
a cover is connected to the cassette frame that is movable between an open position for loading the print medium and a closed position to substantially prevent the print medium from being contaminated.

19. An image forming apparatus including a print medium feeding cassette according to claim 18, wherein
the cleaning member is connected to an inner surface of the cover.

20. An image forming apparatus including a print medium feeding cassette according to claim 15, wherein
the cassette frame has an entry portion through which a pick-up plate is adapted to extend to engage the tray to facilitate moving the tray upwardly.
